(19) United States
(12) Patent Application Publication
(10) Pub. No.: US 2009/0038809 A1
(43) Pub. Date: Feb. 12, 2009

(54) METHOD AND APPARATUS IN A SPRAYING INSTALLATION

(76) Inventor: Goran Sundholm, Tuusula (FI)

Correspondence Address: LADAS & PARRY LLP, 26 WEST 61ST STREET, NEW YORK, NY, 10023, US

(21) Appl. No.: 12/279,212

(22) PCT Filed: Mar. 6, 2007
(86) PCT No.: PCT/FI07/50118

§ 371 Date: Aug. 13, 2008

(30) Foreign Application Priority Data
Mar. 6, 2006 (FI) 20060216
Apr. 27, 2006 (FI) 20060400

(51) Int. Cl. A62C 2/00; B05B 17/04; A62C 35/68

(52) U.S. Cl. 169/34; 239/13; 169/16

(57) ABSTRACT

A method in a spraying installation, especially in a fire extinguishing installation, which comprises a source (1) of a medium to be sprayed and means (5, 15, 17, 18) for conveying the medium to be sprayed from the medium source to at least one spray head (20), through which the medium is sprayed when desired. The method comprises circulating the medium to be sprayed via at least one medium treatment unit (2) and/or manipulating the temperature of the medium at least when necessary. The invention also relates to an apparatus.

### BACKGROUND OF THE INVENTION

The present invention relates to a method as defined in the preamble of claim 1 for use in a spraying installation, especially in a fire extinguishing installation, which comprises a source of a medium to be sprayed and means for conveying the medium to be sprayed from the medium source to at least one spray head, through which the medium is sprayed when desired.

The invention also relates to an apparatus as defined in the preamble of claim 13 for use in a spraying installation, especially a fire extinguishing installation, which comprises a source of a medium to be sprayed and means for conveying the medium to be sprayed from the medium source to at least one spray head.

In spraying installations, especially in fire extinguishing installations, the sprayed medium, such as extinguishing medium, typically remains for long periods in the containers and/or piping of the system. Therefore, there may arise problems due to impurities in the sprayed medium, such as extinguishing medium, and, on the other hand, micro-organisms, such as bacteria, viruses etc. that may be present in the medium. These may involve a disadvantage especially in applications where strict requirements regarding hygiene are to be observed. Applications in which an impure sprayed medium, such as extinguishing medium, may lead to harmful consequences include e.g. hospitals. For example, surgical patients in hospitals may suffer disastrous consequences from the surgical wound being subjected to an impure sprayed medium, such as extinguishing medium, as a result of activation of the extinguishing system. Another problem in existing fire extinguishing systems may result from a difference of temperature of the extinguishing medium and the facility to be protected, because too large a temperature difference may also lead to harmful consequences, such as, in the case of hospital patients, an increased risk of various complications.

The object of the present invention is to create a completely new type of solution that will make it possible to avoid certain drawbacks of prior art. An important objective of the invention is to achieve a solution that will allow a sprayed medium, such as the extinguishing medium in a fire extinguishing system, to be kept in a condition fulfilling the relevant hygienic requirements as closely as possible. A further objective of the invention is to create a fire extinguishing system applicable in places subject to high hygienic requirements, such as hospitals. Yet another objective of the invention is to achieve a fire extinguishing system in which the temperature of the extinguishing medium can be kept within a prescribed range.

### BRIEF DESCRIPTION OF THE INVENTION

The invention is based on a concept wherein a medium intended to be sprayed, especially an extinguishing medium in a fire extinguishing system, is circulated continuously or periodically through a treatment unit where the extinguishing medium can be subjected to desired treatments, such as purification treatments.

More precisely defined, the method of the invention is mainly characterized in that the method comprises circulating the medium to be sprayed through at least one medium treatment unit, and/or manipulating the temperature of the medium at least when necessary.

The method of the invention is additionally characterized by what is stated in claims 2-12.

The apparatus of the invention is characterized in that it comprises at least one treatment unit and means for circulating at least a portion of the medium to be sprayed through a treatment unit.

The apparatus of the invention is additionally characterized by what is stated in claims 13-24.

The solution of the invention has numerous significant advantages. By circulating the sprayed medium through a treatment unit, it is possible to maintain a suitable level of properties of the medium, such as a level of purity and/or temperature. For example, the invention makes it possible to implement fire protection of spaces requiring a high level of hygiene in a manner allowing the properties of the extinguishing medium to be adapted to the requirements imposed by the environment. Thus, when the fire extinguishing system e.g. in a hospital is activated, the risks of the extinguishing medium causing complications in patients can be minimized. The invention allows different treatments to be arranged in the treatment unit as required. The treatment apparatus may comprise e.g. ultraviolet treatment, various filtering treatments and/or chemical treatment of the sprayed medium. The invention makes it possible to remove e.g. harmful particles and/or organisms from the medium. By providing temperature control in conjunction with the invention, it is possible to maintain a desired temperature of the medium. By providing the medium source or the treatment unit with a heating device, such as a thermal resistor, and at the same time circulating the medium in the system, the temperature of the medium can be maintained at a desired level in different parts of even very large systems. Circulation of the medium allows a desired level of purity of the medium to be maintained as the medium is circulating through a treatment unit. On the other hand, this simultaneously ensures that the medium will not stagnate in the piping. Moreover, the temperature remains at a suitable level as the water is circulating through the coverage area of the heating element. According to a preferred embodiment of the invention, part of the circulation circuit can be implemented using components more economical than piping intended for actual extinguishing use, e.g. pipe designed for low-pressure use, such as plastic pipe or hose, or valve elements. Circulation circuit components adapted for a lower pressure and/or rate of flow are typically smaller in size and weight. In addition, they are easy to install. The circulation circuit can also be utilized in systems for maintaining a standby pressure in fire extinguishing pipes. By using the actual fire extinguishing pipes as the return conduit of the circulation circuit, an advantageous alternative for implementing circulation is achieved. By providing the system with pressure and/or flow restricting elements, the circulation circuit components designed to be working under a lower pressure and/or flow than the components of the actual fire extinguishing system can be protected when the extinguishing system is activated.

### BRIEF DESCRIPTION OF THE FIGURES

In the following, the invention will be described in detail by referring to an example and the attached drawing, wherein

FIG. 1 presents a diagram representing a solution according to the invention,

FIG. 2 presents a diagram representing a second embodiment of the invention,

FIG. 3 presents a diagram representing a third embodiment of the invention,

FIG. 4 further presents a diagram representing a fourth embodiment of the invention, and

FIG. 5 presents a diagram representing yet another embodiment of the invention.

### BRIEF DESCRIPTION OF THE INVENTION

The invention relates to a method in a spraying installation, especially a fire extinguishing installation, which comprises a source 1 of a medium to be sprayed and means 5, 15, 17, 18 for conveying the sprayed medium from the medium source to at least one spray head 20, through which the medium is sprayed when desired. In the method, the medium to be sprayed is circulated through at least one medium treatment unit 2.

According to an embodiment of the method, the medium is treated in the at least one medium treatment unit 2 by filtering and/or purifying and/or by treating it chemically and/or biologically and/or by manipulating the temperature of the medium at least when necessary.

At least a portion of the medium in the pipe system 15, 17, 18, 19 designed to convey the medium and/or in the medium source 1, such as a tank, is circulated through the treatment unit 2. Typically the medium is circulated via the treatment unit 2 at least when the spraying installation is not in an activated state.

According to an embodiment of the invention, the temperature of the medium to be sprayed is manipulated. In an embodiment, the temperature of the medium to be sprayed is regulated.

In an embodiment of the invention, the medium to be sprayed is typically an aqueous medium. In a fire extinguishing installation, it is possible to use e.g. an aqueous medium, which may contain suitable additives.

According to an embodiment of the method, the medium is circulated at a pressure lower than the actual spraying pressure. In the method, the medium is circulated via the treatment unit 2 periodically or continuously. According to a preferred embodiment of the method, the medium is circulated in the pipe system in the reverse direction relative to the direction of medium circulation in the extinguishing pipes after activation of the actual extinguishing system.

In an embodiment of the method, the medium is circulated through at least some of the spray heads. According to the method, depending on the application, it is thus possible to form different medium circulation arrangements where the circulation covers the entire system or only a part of it.

The invention also relates to an apparatus in a spraying installation, especially in a fire extinguishing installation, which comprises a source of a medium to be sprayed and means 5, 15, 17, 18 for conveying the sprayed medium from the medium source to at least one spray head 20. The apparatus comprises at least one treatment unit 2 and means 3, 16 for circulating at least a portion of the medium to be sprayed through the treatment unit.

In an embodiment, the treatment unit 2 comprises e.g. means for filtering and/or purifying the medium and/or means for chemical treatment of the medium and/or means for manipulating the temperature of the medium. In the treatment unit, the medium can be subjected to various treatments, such as filtering, purification or chemical treatment. The applicable treatments may include almost all treatments used for water purification.

According to an embodiment, the apparatus comprises means 21 for adjusting the temperature of the medium.

According to an embodiment, the apparatus comprises means 20, such as at least one spray head, for producing and spraying a medium spray, preferably a medium mist, especially a water mist, preferably a high-pressure water mist, after the system has been activated.

The apparatus comprises a pump means 5, most appropriately a high-pressure pump, for conveying the sprayed medium to at least one spray head 20 at least after activation of the system. Certain components of the system may have been adapted for a lower pressure, and therefore the system comprises means for averting the effect of the high pressure on these components. These components are typically various valve elements. For example, the circulation circuit 16 is provided with a check valve 4 to avert the effect of pressure from the pressure side of the pump means after the pump 5 has been started.

In an embodiment, the spray head 20 is a spraying head, such as a sprinkler head, designed for fire extinguishing purposes.

In an embodiment, the apparatus comprises a circulation circuit, which is connected in conjunction with a spraying system, such as a fire extinguishing system, and which comprises a circulation pump 3, at least one treatment unit 2 and a conduit 16.

In another embodiment, the apparatus preferably comprises means for producing medium circulation substantially through at least some of the spray heads 20.

The apparatus comprises means, such as valve elements and/or choker elements, for controlling and/or adjusting the circulation of the medium in the spraying installation.

According to an embodiment, the spraying apparatus of the invention can be used as a fire extinguishing system especially for hospitals, laboratories and other facilities where the purity and other properties of the extinguishing medium to be sprayed are subject to high requirements. The extinguishing medium, especially aqueous extinguishing medium in the conduitry used to convey the extinguishing medium is kept as pure as possible by circulating it through treatment devices, such as purification devices, especially water purification devices, in the treatment unit 2. In addition, the temperature of the sprayed medium, such as extinguishing medium, especially water in the system can be manipulated, e.g. by keeping the temperature within a desired range, e.g. between +20-+30 degrees. Thus, the temperature difference of the extinguishing medium relative to the temperature of the facility to be protected will not fall or rise beyond the desired temperature range. After the extinguishing system has been activated, in conjunction with the triggering of a nozzle, possible complications caused in hospital patients e.g. by excessively cold water can thus be minimized.

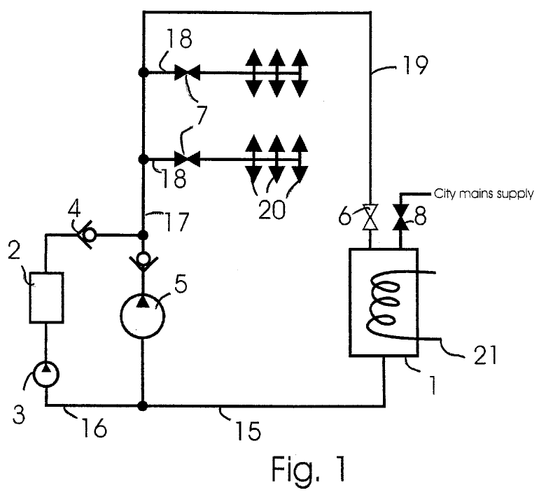

The fire extinguishing system of the invention can be implemented as different embodiments. In the following, four preferred embodiments will be described. In connection with each alternative, features added as new aspects as compared to previous embodiments are explained. FIG. 1 presents an embodiment in which, in standby mode, the extinguishing medium, especially aqueous extinguishing medium of the system circulates from a continuously or periodically heated water tank 1 via a conduit 15, 16 into a treatment unit 2, such as a water treatment apparatus, through e.g. a low-pressure circulation water pump 3 and a check valve 4 separating the high-pressure and low-pressure circuits, through the distribution conduitry 17 of the system and finally through a return conduit 19 and return valve 6 back into the medium source, such as water tank 1.

The size of the water tank 1 depends on the volumetric capacity of the piping of the system and it is so designed that, with the thermal resistors 21 placed in it and with a correct water circulation speed, the temperature in every part of the system is e.g. +20-+30 degrees. Another factor that may affect the size of the tank is the required length of time during which there should be enough warm purified water to feed the open nozzles of the spray heads 20.

In an embodiment, the treatment unit 2 may contain e.g. ultra-violet treatment of the water, special filters and chemical and/or biological treatment of the water. An embodiment of the apparatus is designed to remove harmful particles or organisms from the water in the system as far as possible.

The circulation pump 3 circulates the medium in the system either continuously or at certain time intervals. The purpose of the circulation of the medium, e.g. water, is to maintain desired properties of the medium, e.g. so that it meets certain hygienic requirements, and to keep it within a desired temperature range, via continuous or periodic purification and by supplying warm medium from the tank 1, and at the same time to prevent the medium to be sprayed from stagnating in the piping.

The check valve 4 prevents the admission of high pressure to the circulation water pump 3 after the main pump unit 5 of the system has been started. The return valve 6 again prevents the admission of high pressure into the water tank. The return valve 6 may be e.g. an electrically or hydraulically controlled valve, the return valve being closed by a rise of pressure in the piping 17, 18, 19.

The medium to be sprayed which is contained in the medium source, such as tank 1, may even originally be a medium of desired properties, such as pure water, and it can be additionally arranged to be changed when necessary, e.g. at desired intervals. When the spraying installation is activated, e.g. in a fire situation, and the tank 1 is exhausted, additional medium can be supplied via a filling valve 8 e.g. from a water supply network.

In this embodiment according to FIG. 1, the system is confined to circulating only a certain portion of the water in the system piping, from the pump 5 to the local valves 7, so the part of conduit 18 extending from the valves 7 to the spray heads 20 is left outside the circulation.

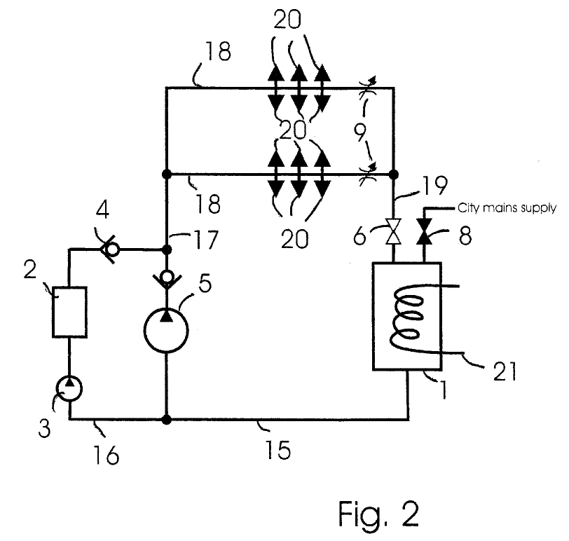

FIG. 2 presents a second embodiment of the invention, in which even the distribution lines 18 feeding the nozzles 20 are included in the medium circulation circuit. Using flow control elements 9, such as throttle elements, especially adjustable throttles, the rates of volume flow through different sprinkler areas can be balanced. Alternatively, it is possible to use e.g. non-variable throttles defined by calculating.

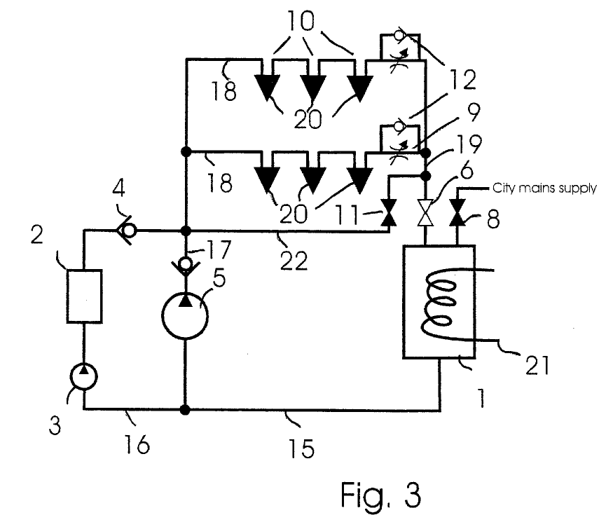

FIG. 3 presents a third embodiment of the invention, in which solution the medium is circulated through the spray heads 20 as well, e.g. by utilizing a suitable spray head mounting socket arrangement 10. In addition, via a valve 11 which in the standby state is closed, the conduit 22 normally serving as a medium return line can also be used in a fire situation to supply medium to the spray head 20, thus making it possible to achieve smaller pressure losses per supply conduit, which further allows smaller conduit sizes.

The check valves 12 placed in conjunction with the throttles 9 permit medium flow from the direction of conduit 19 without significant losses.

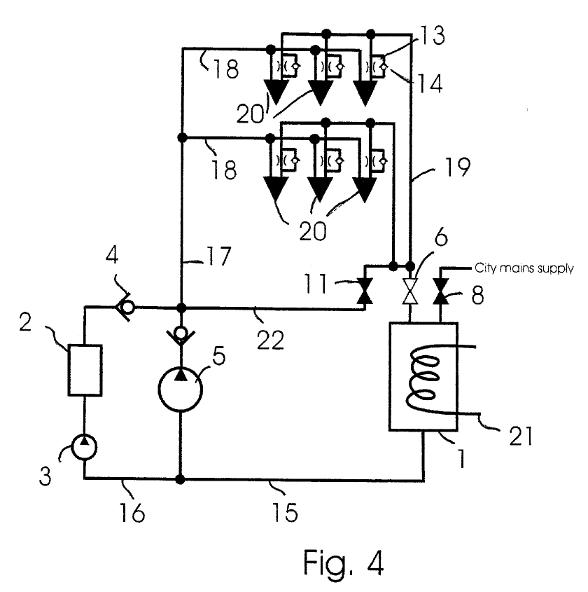

FIG. 4 presents a fourth embodiment, which is so implemented that water is circulated past every nozzle. Each nozzle socket is directly connected to two different pipes. Throttles 13 provide a by-pass for each nozzle. Check valves 14 again allow the water circulation return lines to be used in a fire situation as water supply lines as well.

In the embodiments illustrated in FIGS. 1 and 2, the return line 19 can naturally by connected directly to the pump by using a check valve in between. In this case, too, it may be possible to reduce the conduit sizes.

To ensure detection of activation of the spray head, e.g. in a fire situation the triggering of a sprinkler, the circulation water pump 3 and the throttles in the piping are so designed that opening of the sprinkler will cause a clear pressure fall in the piping.

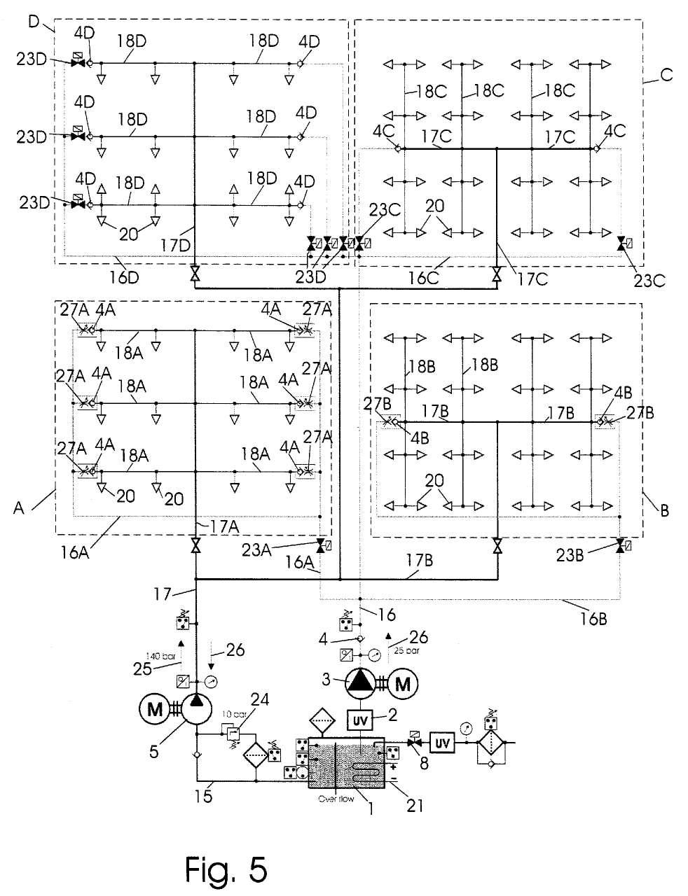

FIG. 5 presents yet another embodiment of the invention. Here, medium circulation in the circulation circuit is so arranged that at least in part of the piping the medium circulates in the reverse direction (arrow 26 in FIG. 5) relative to the direction (arrow 25 in FIG. 5) of medium flow in an activated state of the extinguishing system. In the embodiment illustrated in FIG. 5, liquid is circulated by a circulation pump 3 from a medium source 1 initially through a treatment unit 2 via a pipe means 16. In the diagram in FIG. 5, the treatment unit 2 is a radiation unit where the liquid to be circulated is subjected to radiation. In the case of this diagram, the system uses especially ultraviolet radiation (UV), i.e. ultraviolet treatment. From the treatment unit 2, the medium is conveyed by means of the circulation water pump 3 via the circulation circuit piping 16, which is connected at its first end to the medium source and at its second end to the actual extinguishing piping 17, 18. Circulation takes place either continuously or e.g. in pulses by opening a valve 23A, 23B, 23C, 23D, such as e.g. a solenoid valve in the circulation circuit at desired intervals. One or more valves can be opened at a time. The valves can be opened in a given order. According to an embodiment, the valves 23A, 23B, 23C, 23D are opened in a certain order for a short time, e.g. 5 minutes at a time. It is thus possible to circulate the medium in desired parts of the system e.g. so that circulation only takes place in part of the piping at a time.

In the embodiment in the figure, the yield of the circulation pump 5 is substantially lower than the sprinkler flow. According to an embodiment, the yield of the circulation pump is e.g. of the order of 5-20%, preferably about 10% of the sprinkler flow. In this case, at least part of the piping used in the circulation circuit may be smaller in diameter than the piping intended for actual sprinkler use. Parts 16, 16A, 16B, 16C, 16D used in the circulation piping may be e.g. plastic pipes, preferably low-pressure pipes. The pipes/hoses 16, 16A, 16B, 16C, 16D can be easily mounted, so they do not require any heavy and expensive support. As the pressure of the circulation pump 3 is substantially lower than the pressure (in the example illustrated, of the order of 50-200 bar, preferably 100-150 bar) of the sprinkler pump 5, e.g. of the order of 5-40 bar, preferably 5-25 bar, the valve elements 23A, 23B, 23C, 23D used may be e.g. solenoid valves.

According to a preferred embodiment of the invention, the circulation pump 3 can be used to simultaneously produce a stand-by pressure in the spraying piping 17, 18. The embodiment illustrated proposes a 10-bar counter pressure, which is produced by means of a pressure-relief valve 24 placed on the suction side of the sprinkler pump 5. The pressure loss in the piping would be 15 bar as a maximum. In the embodiment in FIG. 5, it is to be noted that, when the sprinkler pump 5 is not in operation, liquid can be circulated through the pump 5 in the reverse direction relative to the normal pumping direction of the pump. The circulation pump 3 stops when the pump means 5 starts working. Correspondingly, the circulation pump 3 stops if the liquid surface level in the tank 1 falls below a preset value or if e.g. a pipe/hose fracture occurs.

The arrangement according to the embodiment presented in FIG. 5 allows considerable savings to be achieved when part of the circulation circuit is implemented using pipe of a smaller diameter than the pipe intended for actual sprinkler use. Conduit 16 of the circulation circuit may consist of e.g. pipe/hose intended for low-pressure use, e.g. plastic pipe. On the other hand, the valve elements 23A, 23B, 23C, 23D may be valves suited for lower pressure. Diagram 5 presents different examples of circuit alternatives, of which a suitable one can be selected for each case. In section A, the outflow conduits 16A of the circulation circuit are connected to branch conduits 18A branched out from the main pipeline 17, 17A of the extinguishing system and comprising spraying nozzles 20. Provided in conjunction with the branch conduits 18A and/or circulation conduits 16A are pressure/flow shut-off/adjusting elements 4A, 27A which, after the extinguishing system has been activated, prevent the higher-pressure liquid from getting into the circulation pipes. In the embodiment represented by section A in FIG. 5, the shut-off/adjusting elements comprise a check valve 4A and further a throttle element 27A, which may also be adjustable. The circulation pipe 16A is additionally provided with a valve element 23A, allowing the medium circulation into section A to be adjusted by opening/closing this valve. In the embodiment illustrated in the figure, the main pipeline 17, 17A of the extinguishing system serves as the return line of the circulation circuit, so the medium can flow through the pump device 5 into the tank 1.

A somewhat simpler solution than in section A is presented in section B of FIG. 5, where the outflow conduits 16B of the circulation circuit are only connected to the main pipe branch conduits 17B, no circulation pipe connection to the branch conduits 18B comprising the spraying nozzles 20 being provided. The shut-off/adjusting elements 4B, 27B correspond to those in section A. Likewise, the circulation circuit comprises a valve element 23B by means of which the medium circulation in the circulation circuit is opened/closed. The main pipeline 17, 17B of the extinguishing system serves as the return line of the circulation circuit as in the embodiment in section A.

In section C, the outflow conduits 16C of the circulation circuit are only connected to the main pipe branch conduits 17C, with no circulation pipe connection to the branch conduits 18C comprising the spraying nozzles 20. The shut-off element is a check valve 4C, which, after the extinguishing system has been activated, prevents admission of the higher pressure into the circulation conduits 16, 16C. This embodiment comprises two valve elements 23C by means of which the medium circulation into the branch conduits 17C of the main pipeline 17 in section C can be opened/closed. Here, too, the main pipeline 17, 17C serves as a return line.

The arrangement in section D corresponds to that in section C, but the circulation conduits 16D are connected to each branch conduit 18D comprising spraying nozzles 20. In addition, a separate valve element 23D for opening/closing the medium circulation into the branch conduit 18D is provided in conjunction with each branch 18D. The main pipeline 17, 17D of the extinguishing system serves as the return line of the circulation circuit.

According to an embodiment, the method of the invention can be used in conjunction with spraying systems involving high hygienic requirements. Such systems may include e.g. the fire extinguishing systems of hospitals or extinguishing systems intended for use e.g. in laboratories.

The method and apparatus of the invention can be used in conjunction with extinguishing systems of widely varying types. It is applicable for use in traditional extinguishing systems operated with a low pressure, as well as in modern fire extinguishing systems employing water mist as extinguishing medium. In conjunction with a water-mist extinguishing system, it is possible to use high or low pressure in the piping according to application.

It is obvious to a person skilled in the art that the invention is not limited to the embodiments described above, but that may be varied within the scope of the claims presented below. Features that may have been presented in the description together with other features can also be used separately from each other if necessary.

1. Method in a spraying installation, especially in a fire extinguishing installation, which comprises a source (1) of a medium to be sprayed and means (5, 15, 17, 18) for conveying the medium to be sprayed from the medium source to at least one spray head (20), through which the medium is sprayed when desired, characterized in that the method comprises circulating the medium to be sprayed via at least one medium treatment unit (2) and/or manipulating the tem-perature of the medium at least when necessary.

2. Method according to claim 1, characterized in that the medium is treated in the treatment unit (2) by filtering and/or purifying it and/or by treating it chemically and/or biologically.

3. Method according to claim 1, characterized in that at least a fraction of the medium in a pipe system designed to convey the medium and/or in the medium source (1), such as a tank, is circulated through the treatment unit (2).

4. Method according to claim 1, characterized in that the medium is circulated via the treatment unit (2) at least when the spraying installation is not in an activated state.

5. Method according to claim 1, characterized in that the temperature of the medium to be sprayed is regulated in the medium source (1), such as a tank.

6. Method according to claim 1, characterized in that the medium to be sprayed is an aqueous medium.

7. Method according to claim 1, characterized in that the medium is circulated at a pressure lower than the actual spraying pressure.

8. Method according to claim 1, characterized in that the medium is circulated via the medium treatment unit (2) periodically or continuously.

9. Method according to claim 1, characterized in that the medium is circulated through at least some of the spray heads (20).

10. Method according to claim 1, characterized in that the medium is circulated in the reverse direction relative to the pumping direction of a pump means (5).

11. Method according to claim 1, characterized in that the pressure produced by a circulation pump (3) is utilized as a stand-by pressure of the spraying system.

12. Method according to claim 1, characterized in that the method is used in conjunction with fire extinguishing installations in environments involving high hygienic requirements.

13. Apparatus in a spraying installation, especially a fire extinguishing installation, which comprises a source (1) of a medium to be sprayed and means (5, 15, 17, 18) for conveying the medium to be sprayed to at least one spray head (20), characterized in that the apparatus comprises at least one treatment unit (2) and means (3, 16) for circulating at least a fraction of the medium to be sprayed through the treatment unit (2).

14. Apparatus according to claim 13, characterized in that the treatment unit (2) comprises means for means for filtering and/or purifying the medium and/or means for chemical and/or biological treat-ment of the medium.

15. Apparatus according to claim 13, characterized in that the apparatus comprises means (21) for adjusting the temperature of the medium.

16. Apparatus according to claim 13, characterized in that the apparatus comprises means (20) for producing and spraying water mist after the system has been activated.

17. Apparatus according to claim 13, characterized in that the apparatus comprises a pump means (5), most appropriately a high-pressure pump, for conveying the sprayed medium to at least one spray head (20) at least after the apparatus has been activated.

18. Apparatus according to claim 13, characterized in that the spray head (20) is a spray head intended for fire extinguishing purposes, such as a sprinkler head.

19. Apparatus according to claim 13, characterized in that the apparatus comprises a circulation circuit, which is connected in conjunction with a spraying system, such as a fire extin-guishing system, said circulation circuit comprising a circulation pump (3), at least one treatment unit (2) and a conduit (16).

20. Apparatus according to claim 13, characterized in that the apparatus comprises means for creating medium circula-tion substantially through at least some of the spray heads (20).

21. Apparatus according to claim 13, characterized in that the apparatus comprises means, such as valve elements and/or choker elements, for controlling and/or adjusting the circulation of the medium in the spraying installation.

22. Apparatus according to claim 13, characterized in that the spraying installation is a fire extinguishing installation for environments involving high hygienic requirements.

23. Apparatus according to claim 13, characterized in that at least part of the circulation circuit comprises components, such as conduits and flow-control and flow-blocking elements, adapted for a pressure and/or volume flow smaller than the spraying pressure.

24. Apparatus according to claim 13, characterized in that the circulation pump (3) has been arranged to circulate the medium in the circulation circuit in the reverse direction relative to the pumping direction of the pump means (5) used for spraying.
